(19) United States
(12) Patent Application Publication
(10) Pub. No.: US 2026/0288489 A1
(43) Pub. Date: Sep. 24, 2026

(54) ENTERPRISE ANALYTICS WATCHLIST

(71) Applicant: SAP SE, Walldorf (DE)

(72) Inventors: Justin WONG, Coquitlam (CA); Tsz Hong SUNG, Richmond (CA); Tunir KAPIL, Vancouver (CA)

(21) Appl. No.: 19/085,225

(22) Filed: Mar. 20, 2025

(51) Int. Cl. G06F 9/451; G06Q 10/0639

(52) U.S. Cl. CPC G06F 9/451; G06Q 10/06393

(57) ABSTRACT

A story data store may contain records representing a plurality of data visualization story arrangements associated with Key Performance Indicator (“KPI”) elements of an enterprise, each record including a story identifier. A watchlist data store may contain records that represent a plurality of watchlist layouts associated with the enterprise, each record including a watchlist identifier and at least one KPI display widget. A watchlist support platform may access a first data visualization story arrangement from the story data store and receive, from a user, a selection of a KPI element of the first data visualization story arrangement. A KPI display widget can then be added to a watchlist layout in the watchlist data store based on the selected KPI element of the first data visualization story arrangement. The watchlist support platform may then render a watchlist display, based on the watchlist layout, including the added KPI display widget.

### BACKGROUND

An enterprise may use an analytics cloud for planning that is designed to improve investments business applications and valuable data sources. In some cases, the analytics cloud may utilize Artificial Intelligence (“AI”) to automate reporting, discover hidden insights, and/or create business plans. The analytics cloud may provide business intelligence capabilities and industry-specific analytics (e.g., with pre-built business content) and enable collaborative planning by unifying financial, supply chain, and operational planning.

Moreover, information associated with the enterprise may be shown to a user via a data visualization story created to capture insights and visualizations. Different stories may focus on different purposes, such as planning, forecasting, including complex features such as scripting, and so on. A designer may create stories that use charts and tables to visualize the data, as well as custom widgets and filters to help control what information is available and how much is visible at a time.

An enterprise may use a wide range of features to construct stories that capture the complexity of an organization's unique circumstances. FIG. 1A is a dashboard story creation display 100 for various analytics cloud applications 110. After selecting “Start” 120, a designer or user may select a particular type of arrangement 130 (e.g., via a computer mouse pointer 190) from options associated with various enterprise units and story templates 140. The story acts as a container object that holds the data, visualizations, and other elements of the visualization. Users may decide how to organize and consume content by defining story-level settings, choosing specific page types and other elements to define the structure and delivery format of the story, such as enabling it to be viewed on mobile devices, and applying best practices to optimize story performance. To explore and display data in various formats, it may be organized into measures or accounts, which are numeric values that can be aggregated and included in calculations such as gross margin or quantity sold, and dimensions, which are different characteristics that can be used to group or divide these values such as date, location, or product. A story can contain multiple data sources, and widgets may be mapped to different data sources to the same page or link data sources across shared dimensions (to display blended data).

The display 100 may let a user visualize story data in charts, tables, geographic maps, etc. To help focus on relevant data, filters can be applied to a story, widgets, or points in individual charts, tables, and other visualization. After defining how to present the data, the display 100 may let a user customize the look of the story by applying styling options for various page elements, adjusting layouts, and adding other design-focused widgets (e.g., such as shapes, images, and text). When complete, the story is ready to be utilized and/or shared with other enterprise users. For example, FIG. 1B is a dashboard story display 101. The story display 101 includes enterprise values and filter widgets 111. The display 101 may also include an arrangement of enterprise story visualizations 151 and enterprise data and filters 161.

In some cases, a user might want to create a “watchlist” of selected elements in the story display 101 to monitor particular enterprise values. However, it can be difficult, time consuming, and costly to efficiently create such a watchlist-especially when there is a substantial amount of enterprise information and/or a large number of stories and widgets to be considered. It would be desirable to provide watchlist support in a secure, automatic, and efficient manner.

### SUMMARY

According to some embodiments, methods and systems may include a story data store that contains records representing a plurality of data visualization story arrangements associated with Key Performance Indicator (“KPI”) elements of an enterprise, each record including a story identifier. A watchlist data store may contain records that represent a plurality of watchlist layouts associated with the enterprise, each record including a watchlist identifier and at least one KPI display widget. A watchlist support platform may access a first data visualization story arrangement from the story data store and receive, from a user, a selection of a KPI element of the first data visualization story arrangement. A KPI display widget can then be added to a watchlist layout in the watchlist data store based on the selected KPI element of the first data visualization story arrangement. The watchlist support platform may then render a watchlist display, based on the watchlist layout, including the added KPI display widget.

Some embodiments comprise: means for accessing, by a computer processor of a watchlist support platform, a first data visualization story arrangement from a story data store containing electronic records that represent a plurality of data visualization story arrangements associated with KPI elements of an enterprise, each record including a story identifier; means for receiving, from a user, a selection of a KPI element of the first data visualization story arrangement; means for adding, based on the selected KPI element of the first data visualization story arrangement, a KPI display widget to a watchlist layout in a watchlist data store containing electronic records that represent a plurality of watchlist layouts associated with the enterprise, each record including a watchlist identifier and at least one KPI display widget; and means for rendering a watchlist display, based on the watchlist layout, including the added KPI display widget.

Some technical advantages of some embodiments disclosed herein are improved systems and methods to provide watchlist support in a secure, automatic, and efficient manner.

### BRIEF DESCRIPTION OF THE DRAWINGS

FIG. 1A is a dashboard story creation display.

FIG. 1B is a dashboard story display.

FIG. 2 is a high-level system architecture in accordance with some embodiments.

FIG. 3 is a watchlist support method according to some embodiments.

FIG. 4 is a user watchlist architecture in accordance with some embodiments.

FIG. 5 is a watchlist display according to some embodiments.

FIG. 6 is a watchlist application shell in accordance with some embodiments.

FIGS. 7 through 12 illustrate watchlist creation and modification according to some embodiments.

FIG. 13 is a multi-user watchlist architecture in accordance with some embodiments.

FIG. 14 is an analytics cloud system in accordance with some embodiments.

FIG. 15 is a watchlist sort example according to some embodiments.

FIGS. 16A through 16C are illustrations of variance position options in accordance with some embodiments.

FIG. 17 is an apparatus or platform according to some embodiments.

FIG. 18 illustrates a tablet computer watchlist display according to some embodiments.

FIG. 19 is an operator or administrator watchlist support display in accordance with some embodiments.

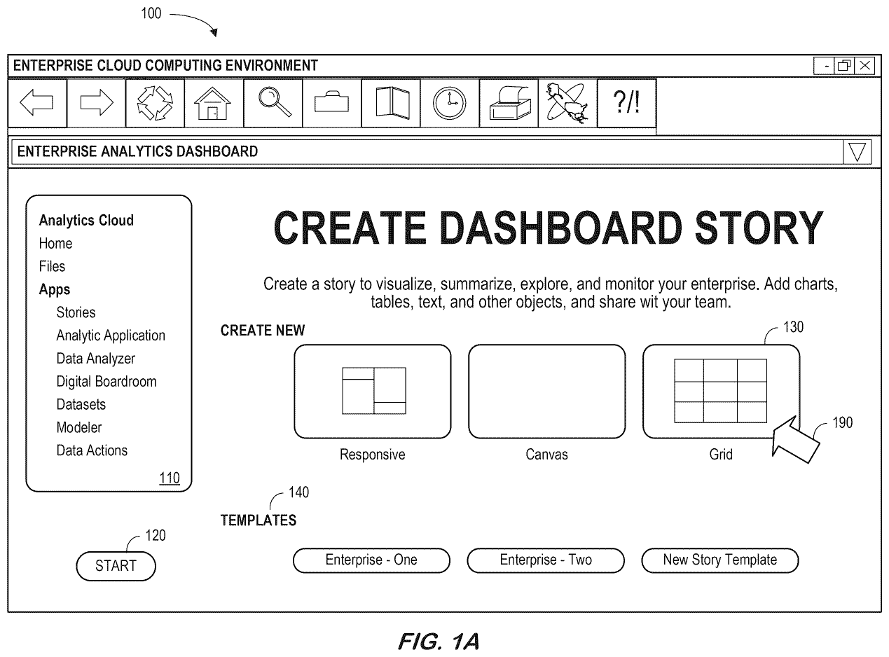

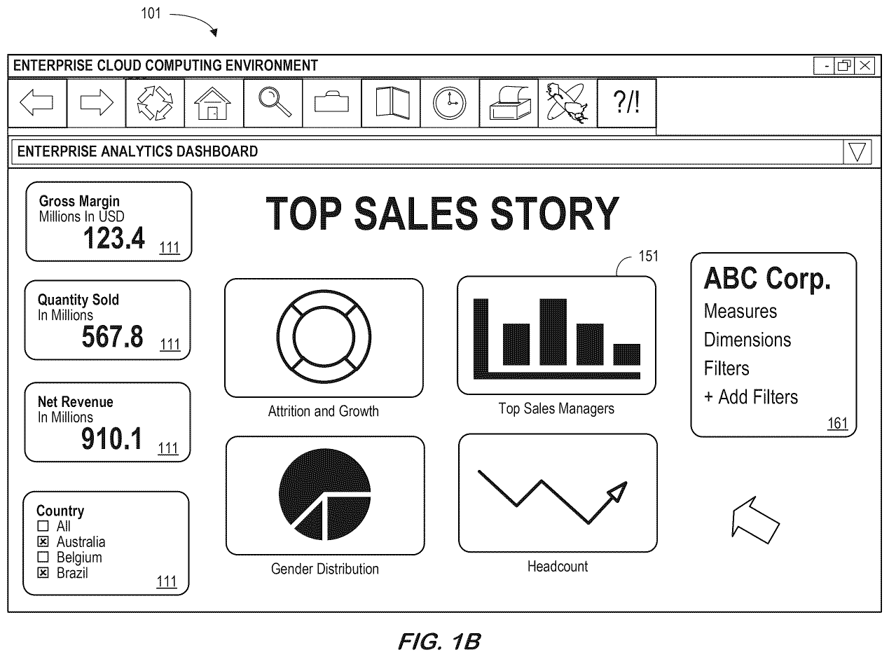

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

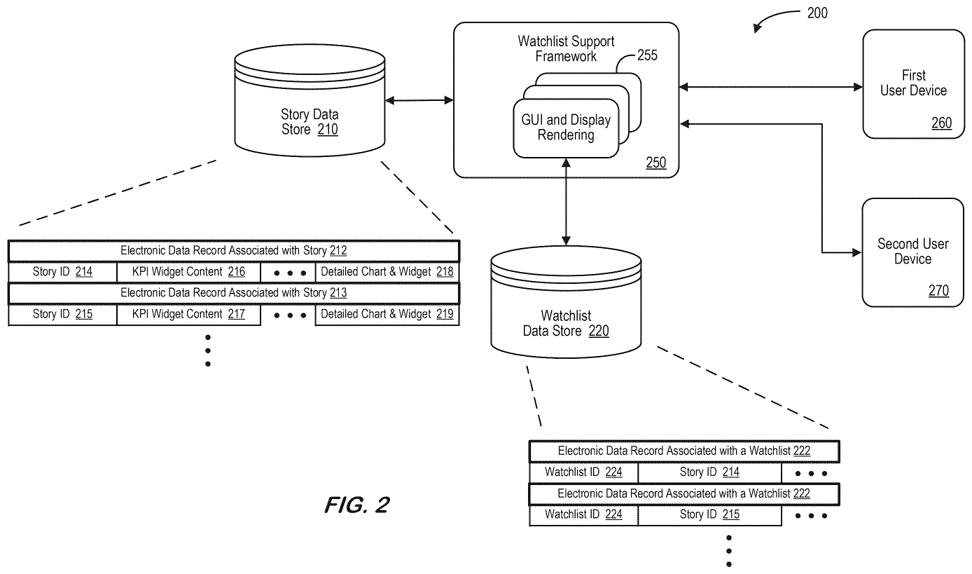

FIG. 2 is a high-level block diagram of one example of a system 200 architecture according to some embodiments. In particular, a story data store 210 may contain structured and/or unstructured information, such as data records associated with a story 212, 213, a story identifier 214, 215, KPI widget content 216, 217, detailed chart widget content 218, 219, enterprise goals, financial results, best practices, etc. A watchlist data store 220 may contain electronic data records associated with a watchlist 222. Each record might, for example, contain a watchlist identifier 224, a story identifier 214, 215, etc. As shown in FIG. 2, watchlist identifier 224 contains two KPIs (one from story 214 and one from story 215). The system 200 may include a watchlist support framework 250 with Graphical User Interface (“GUI”) and rendering 255 that can provide watchlist support capabilities via interactions with first and second user devices 260, 270.

As used herein, devices, including those associated with the system 200 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The watchlist support framework 250 may store information into and/or retrieve information from various data stores (e.g., the story data store 210 and watchlist data store 220), which may be locally stored or reside remote from the watchlist support framework 250. Although a single multi-agent watchlist support framework 250 is shown in FIG. 2, any number of such devices may be included. Moreover, various devices described herein might be combined according to embodiments of the present invention. For example, in some embodiments, the watchlist data store 220 and watchlist support framework 250 might comprise a single apparatus. The system 200 functions may be performed by a constellation of networked apparatuses, such as in a distributed processing or cloud-based architecture. In some cases, the watchlist support framework 250 may process information associated with a number of different enterprises, tenants, or customers.

The system 200 may be accessed via a remote device (e.g., a Personal Computer (“PC”), tablet, or smartphone) to view information about and/or manage operational information in accordance with any of the embodiments described herein. In some cases, an interactive GUI display may let an operator or administrator define and/or adjust certain parameters via a remote device (e.g., to specify how the elements connect with an enterprise computing environment infrastructure) and/or provide or receive automatically generated recommendations, alerts, summaries, or results associated with the system 200.

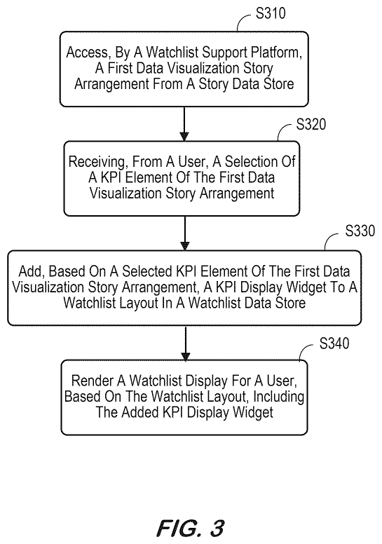

FIG. 3 is a watchlist support method that might be performed by some or all of the elements of the system 200 described with respect to FIG. 2. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

According to some embodiments, a watchlist stores references to a “mini story” identifier. The “mini story” may still be stored in story data store 210. For example, the watchlist may store a list of “mini story” identifiers and some layout settings. The “mini story” may contain a KPI display widget and a detailed chart widget. The watchlist storage may be a first table and the story data may be a second table. The watchlist table may then reference the story table via the identifiers.

At S310, a computer processor of a watchlist support platform (e.g., associated with cloud-based enterprise analytics) may access a first data visualization story arrangement from a story data store containing electronic records that represent a plurality of data visualization story arrangements associated with Key Performance Indicator (“KPI”) elements of an enterprise (e.g., charts and graphs), with each record including a story identifier. As used herein, the term “KPI” may refer to a measurement associated within organization or a particular activity (e.g., programs, products and other initiatives) in which it engages providing a focus for strategic and operational improvement and/or create an analytical basis for decision making.

At S320, a selection of a KPI element of the first data visualization story arrangement may be received from a user. According to some embodiments, a data visualization story arrangement might be loaded via Java Script Object Notation (“JSON”). At S330, the system may add, based on the selected KPI element of the first data visualization story arrangement, a KPI display widget to a watchlist layout in a watchlist data store containing electronic records that represent a plurality of watchlist layouts associated with the enterprise, each record including a watchlist identifier and at least one KPI display widget. Moreover, according to some embodiments a watchlist layout created by a first user is shared with a second user. Note that a KPI display widget may be represented as a Hyper-Text Markup Language (“HTML”) element.

At S340, a watchlist display can be rendered based on the watchlist layout (including the added KPI display widget). According to some embodiments, the watchlist display can include a plurality of KPI display widgets and the system may further support KPI insights, summary insights, KPI monitoring, geographic map information, automatically generated alerts, etc. Moreover, a subsequent change to the data visualization story arrangement might not alter the watchlist layout. Further, a rendered watchlist display could be based on context information, such as a filter, a link analysis, a threshold, a calculation, a sort, a rank, etc.

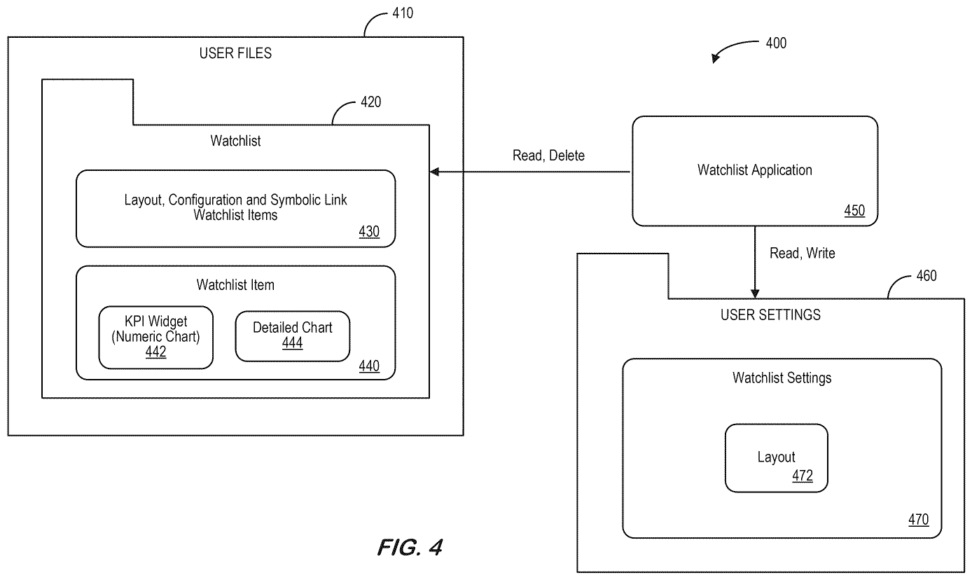

FIG. 4 is a user watchlist architecture 400 in accordance with some embodiments. A watchlist application 450 may access user files 410 (for read and delete) and user settings 460 (for read and write). The user files 410 may include a watchlist 420 with layout, configuration, and symbolic link watchlist items 430 and watchlist items 440, such as a KPI widget (e.g., a numeric chart 442) and a detailed chart 444. The user settings 460 may include watchlist settings 470, such as one or more layouts 472.

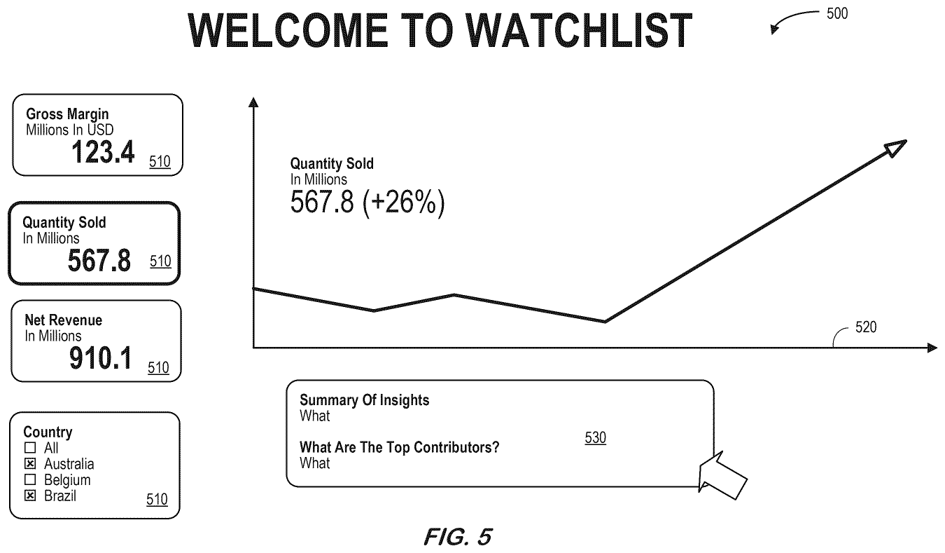

FIG. 5 is a watchlist display 500 according to some embodiments. The display includes KPI widgets 510 and a data visualization 520. According to some embodiments, the watchlist display further includes AI insights 530 (e.g., a widget addon).

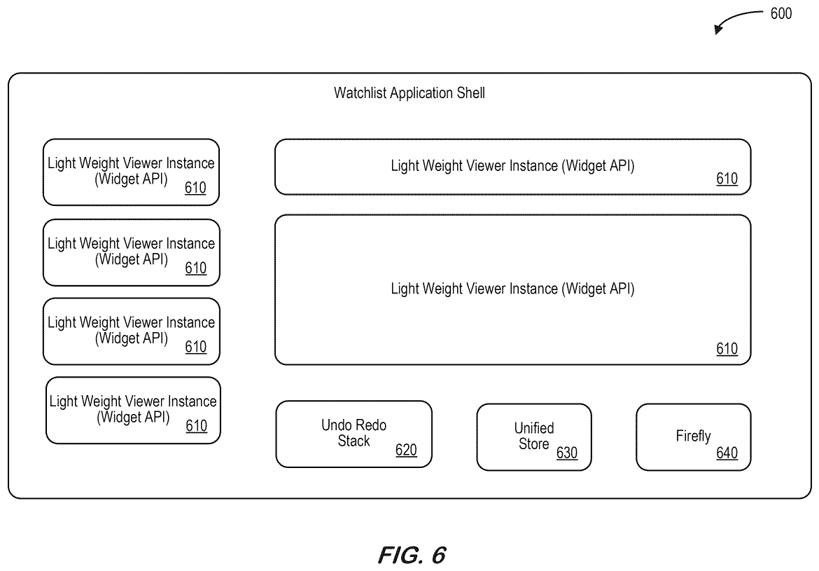

FIG. 6 is a watchlist application shell 600 in accordance with some embodiments. The shell includes Light Weight Viewer (“LWV”) instances, such as widget APIs 610. Multiple instances of the widget APIs 610 may share the same undo redo stack 620, unified store 630, and an API library used for connecting and querying data from different data source providers 640, such as FIREFLY®. A watchlist may comprise a collection of a watchlist items (e.g., a mini-story that is easy to integrate with analytic cloud features). In some embodiments, the watchlist application shell 600 contains multiple instances of widget APIs 610 and supports persisted Information Access (“InA”).

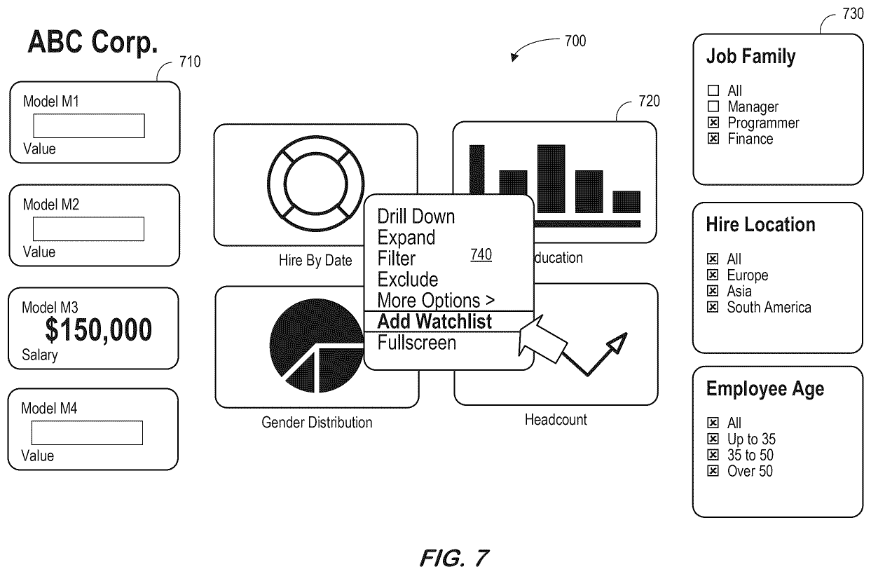

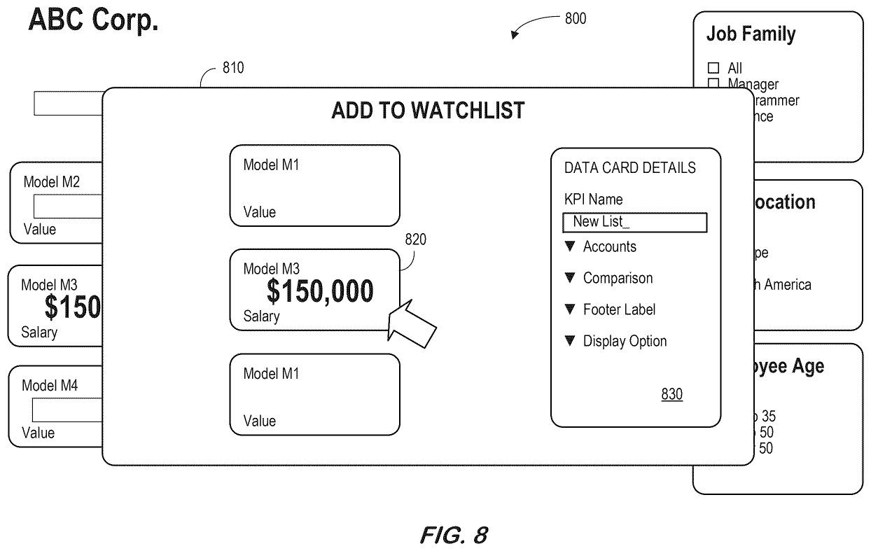

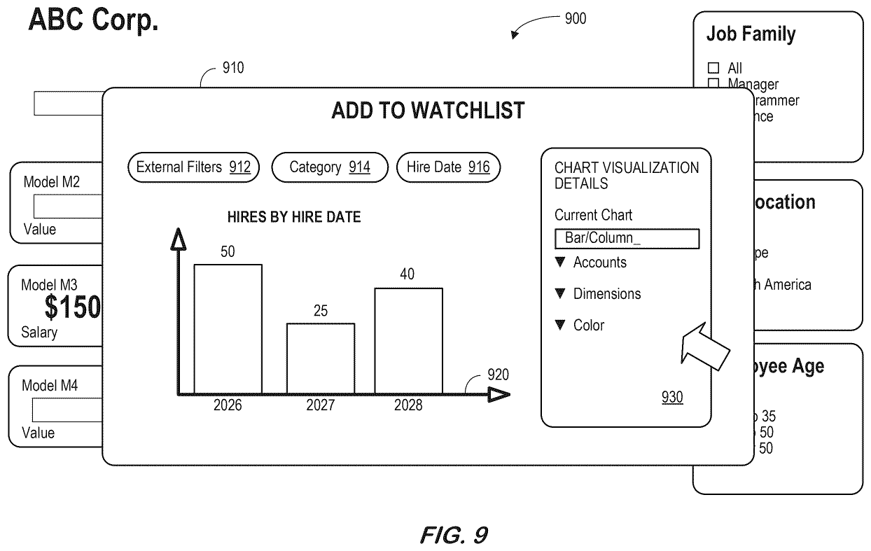

FIGS. 7 through 12 illustrate watchlist creation and modification according to some embodiments. In particular, FIG. 7 is an enterprise story display 700 with KPI widgets 710, data visualizations 720, and filters 730. Selection of a data visualization 720 results in a menu 740 that lets a user drill down into the data, expand the data, add a filter, exclude information add a watchlist, etc. Selecting “add a watchlist” in the menu results in an add to watchlist popup window 810 as shown on the display 800 of FIG. 8. The add to watchlist window 810 includes KPI widgets 820 and data card details 830 (e.g., a KPI name, display options, etc.). An add to watchlist popup window 910 may also apply external filters 912, categories 914, and dimension ranges 916 along with a menu 930 of chart visualization details to render a data visualization, such as the graph 920 illustrated on the display 900 of FIG. 9.

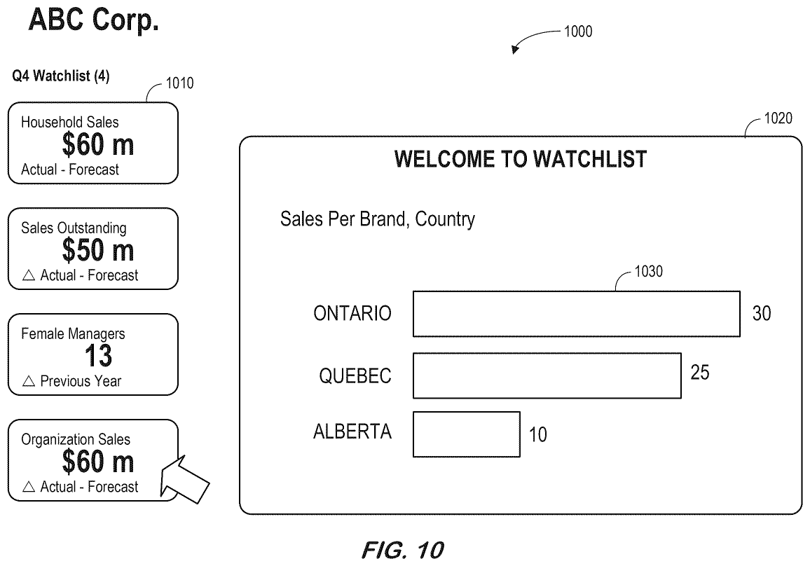

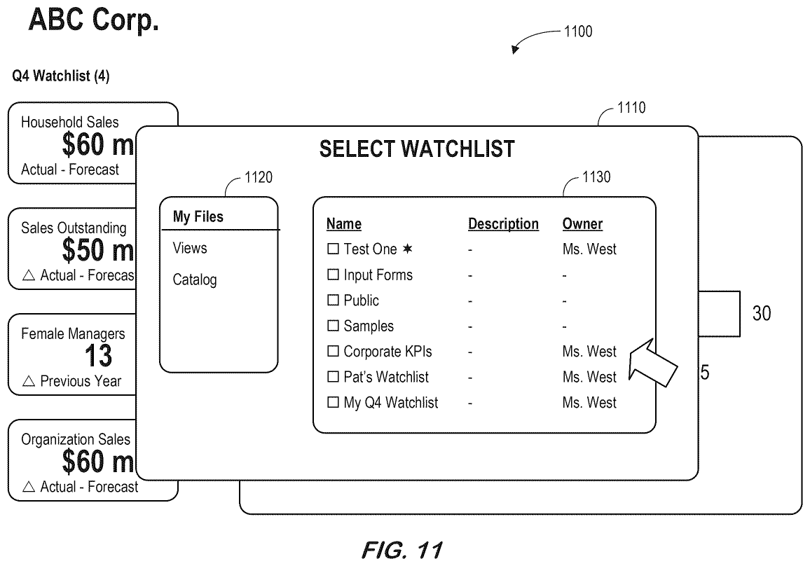

Once a watchlist is defined, it can be shown to a user. For example, FIG. 10 is a watchlist 1000 with KPI widgets 1010 and a data visualization 1020 (e.g., a bar chart 1030 showing sales in various regions). The watchlist support platform may also let a user select an existing watch list. FIG. 11 is a select watchlist display 1100 with a popup window 1110 displaying types of user files 1120 and a list 1130 that can be used one of the watchlists (e.g., a user-defined watchlist or enterprise template).

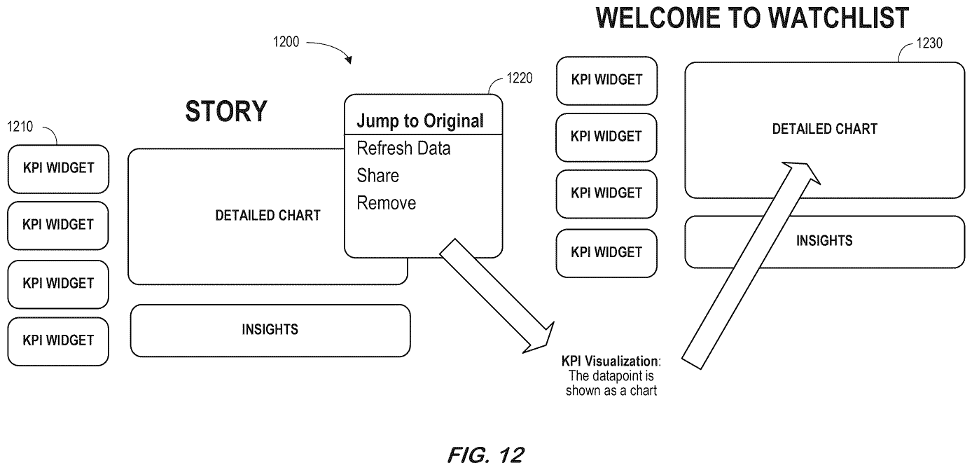

FIG. 12 is an example 1200 including a story display 1210 (e.g., with a list of widgets, a detailed chart, and insights) having a popup menu 1220 that lets a user refresh data, share, or remove a watchlist resulting in a watchlist display 1230. The user may pin a KPI widget to a watchlist based on current story snapshot state, and the watchlist application can run in LiteViewer. Performance may be improved using persisted InA (e.g., metadata download or metadata invalidation) and viewport rendering. Enterprise readiness may be provided for group/team and via personal watchlist permission control and theming or customization. Some embodiments may provide Delivery Completion Indication (“DCI”) and alerting integration (via a snapshot or subscription approach). The list of KPI widgets can be resized or hidden and may be separated into categories. The detailed chart may reflect a datapoint and the insights may include relevant datapoint predictions, explanations, summaries.

According to some embodiments, watchlist items are independent of the original story after being created (that is, if original story changes, the watchlist item is not affected). Moreover, watchlist items may have the data context snapshot of the original story. Each watchlist item uses the same data context as the chart it was created from with data point filter selection and additional filter modifications and the data context might include page filters, story filters, link analysis, filter across model thresholds, calculations, sort, rank, etc. Watchlist items in a watchlist application may have their own data context (and cannot impact each other). In addition, watchlist items may be shared and enterprise ready. In some embodiments, watchlist items can be deleted, copied, exported, and/or shared to other users/groups (with permissions) and may be integrated with mobile, homepage, translations, etc. Watchlist items may also support persisted queries performance optimization and work with an alerting function.

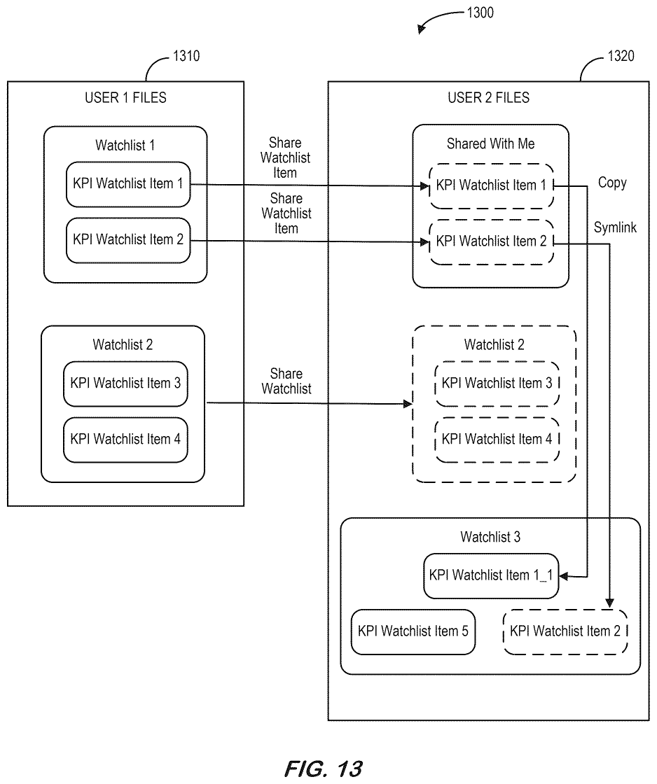

FIG. 13 is a multi-user watchlist architecture 1300 in accordance with some embodiments. User 1 files 1310 include a watchlist 1 (with KPI watchlist items 1 and 2) and a watchlist 2 (with KPI watchlist items 3 and 4). If user 1 shares watchlist item 1 with another user (user 2 files 1320), a copy of item 1 can be placed in a new watchlist (item 1_1 in watchlist 3). In other cases, if user 1 shares watchlist item 2 with user 2, a symbolic link to item 2 might be placed in the new watchlist 3. If user 1 instead shares an entire watchlist 2 with another user, a copy of watchlist 2 can be placed in user 2 files 1320.

In this embodiment, a KPI watchlist item is bound to a watchlist during creation. The parent of a watchlist file repository object (e.g., an Enterprise Performance Management (“EPM”) object) is a folder in user's files/public and a KPI watchlist item EPM object's parent is the watchlist EPM object. A KPI watchlist item can only belong to one watchlist in a user's files. If a user deletes a watchlist, all KPI watchlist items bound to the watchlist are deleted as well as all symbolic links created on the watchlist and KPI watchlist items. A user can also delete individual KPI watchlist items.

The user can share a KPI watchlist item or share a whole watchlist to another user/group. When sharing a KPI watchlist item to another user/group, the KPI watchlist item may appear in a virtual watchlist called “Shared With Me” folder. Shared KPI watchlist items can be added to other watchlists by creating a symbolic link or they may create their own copy of it. When sharing a watchlist itself, the user receiving the shared will see the entire watchlist and it's KPI watchlist items. The watchlist will appear in the “Shared With Me” folder. In FIG. 13, there is a “Shared With Me” folder that shows watchlist items that were shared to user 2 (i.e., KPI watchlist items 1 and 2). The user can then decide to either make a copy of the shared item (in which case, if user 1 deletes the original or changes it, it doesn't impact user 2) or the user can make a “symlink” (e.g., a proxy object) into their own watchlist (in this case, if user 1 deletes or modifies the original watchlist item, then it will impact user 2).

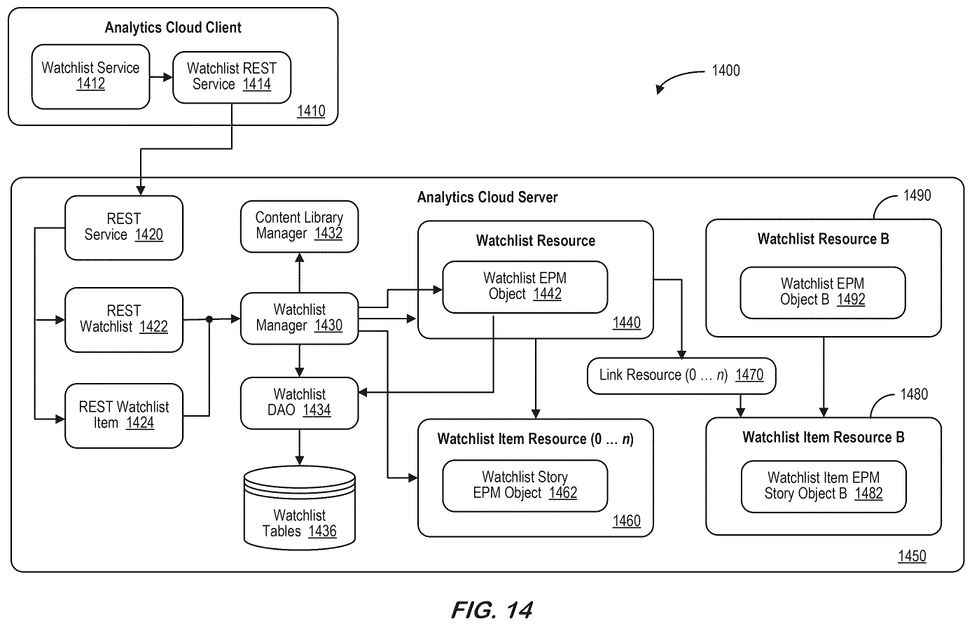

FIG. 14 is an analytics cloud system 1400 in accordance with some embodiments. An analytics cloud client 1410 may communicate with an analytics cloud server 1450. In particular, a watchlist service 1412 may send information to a REST service 1420 in the server 1450 via a watchlist REST service 1414. The REST service 1420 updates a watchlist manager 1430 via a REST watchlist 1422 and a REST watchlist item 1424. The watchlist manager 1430 accesses a content library manager 1432 and stores watchlist tables 1436 via a watchlist Data Access Object (“DAO”) 1434. The watchlist manager 1430 also updates a watchlist EPM object 1442 of a watchlist resource 1440. The watchlist resource 1440 can then update watchlist story EPM objects 1462 for watchlist item resources 1460 (for 0 through n) and link resources 1470 (for 0 through n). A watchlist item resource B 1480 can then use the link resources 1470 and a watchlist item resource B 1490 (with a watchlist EPM object B 1492) a watchlist item EPM story object B 1482.

Note that a numeric point chart may support measure and variance combinations. The KPI widget is based on a snapshot of the story at that point in time, and the story state may be saved with the new numeric point widget. When adding a KPI widget to a watchlist, the system may provide a user with options to create a time series chart if the KPI is based on a time dimension or create a default chart based on the original chart from which the KPI widget was created. This new default chart can be stored in the same internal story. In some embodiments, the KPI widget and default chart are not synchronized to the story (e.g., is weak reference to the original story).

An automatically generated chart may be stored in the same story as the KPI widget. The automatically generated chart may generate a time series chart if the KPI widget uses the time dimension. If there is no time dimension, the system may use the original chart from which KPI widget was created (e.g., only use the measure that is used in KPI).

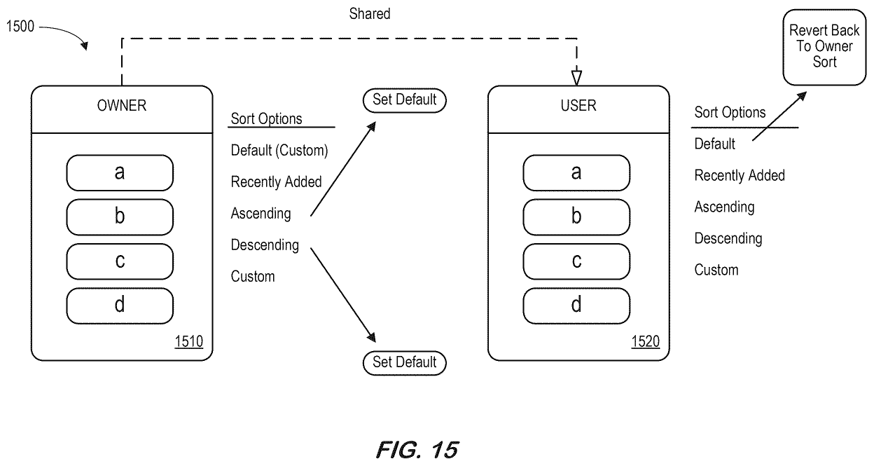

FIG. 15 is a watchlist sort example 1500 according to some embodiments. An owner 1510 may select sort options for list A through D, such as default (custom), recently added, ascending, descending, a custom sort algorithms (e.g., older items might reflect a custom sort while newer items are added to the bottom a list), sort by warnings, sort by errors, etc. These option may then be shared with a user 1520 for list A through D. When sorting, it might not materialize all the KPI widgets (e.g., only materialize what is in view port for performance purposes).

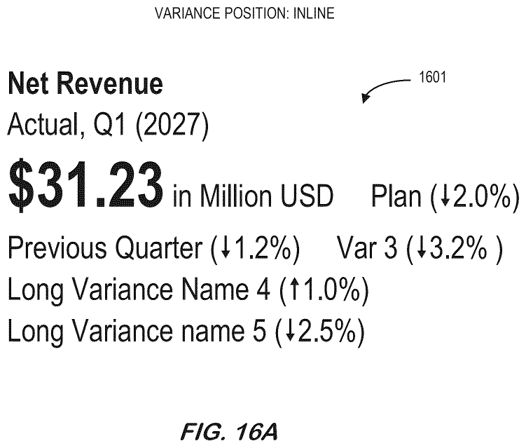

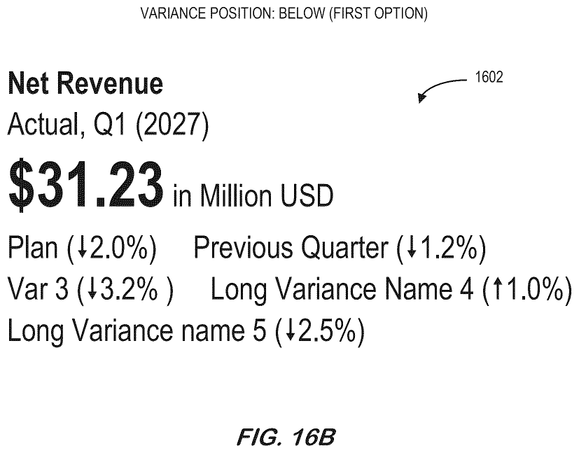

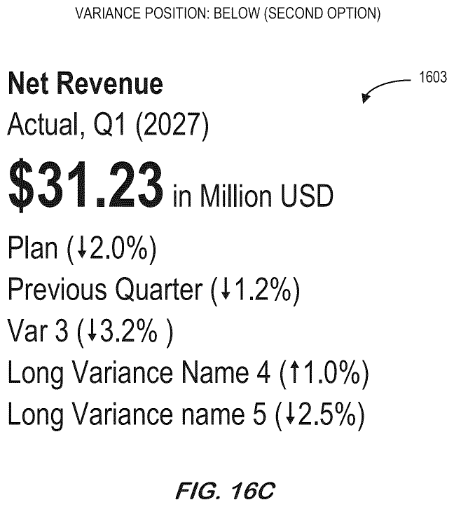

Some embodiments provide for an improved visual design of a numeric point chart. FIGS. 16A through 16C are illustrations of variance position options in accordance with some embodiments. In particular, FIG. 16A shows 1601 “inline” variance positioning. Here, the priority is given to the primary value and its scale. If there is not enough space to display the first variance to the right of the value, it is pushed below. Other variances are placed inline with the first (if the space allows it). Otherwise, they are pushed below. FIG. 16B shows 1602 a first option for “below” variance positioning. In this case, all variances are placed in line with the first (if the space allows it). Otherwise, they are pushed below. FIG. 16C shows 1603 a second option for below variance positioning. Here, all variances are placed below each other.

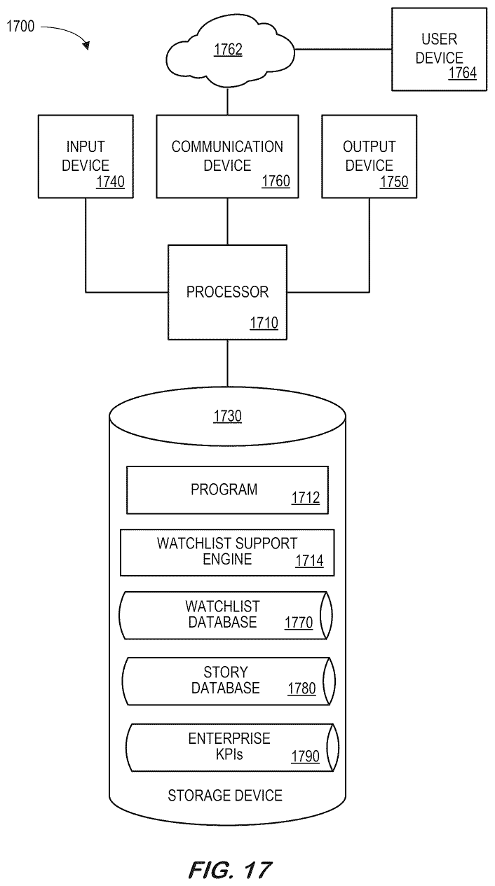

Embodiments described herein may be implemented using any number of different hardware configurations. For example, FIG. 17 is a block diagram of an apparatus or platform 1700 that may be, for example, associated with the system 200 of FIG. 2 (and/or any other system described herein). The platform 1700 comprises a processor 1710, such as one or more commercially available Central Processing Units (“CPUs”) in the form of one-chip microprocessors, coupled to a communication device 1760 configured to communicate via one or more communication networks. The communication device 1760 may be used to communicate, for example, with one or more user devices 1764 via a distributed computer network 1762. The platform 1700 further includes an input device 1740 (e.g., a computer mouse and/or keyboard to input data source information, user settings, etc.) and/an output device 1750 (e.g., a computer monitor to render a display, transmit recommendations, evaluations, alerts, reports about watchlists, etc.).

The processor 1710 also communicates with a storage device 1730. The storage device 1730 may comprise any appropriate information storage device, including combinations of magnetic storage devices (e.g., a hard disk drive), optical storage devices, mobile telephones, and/or semiconductor memory devices. The storage device 1730 stores a program 1712 and/or watchlist support engine 1714 for controlling the processor 1710. The processor 1710 performs instructions of the programs 1712, 1714, and thereby operates in accordance with any of the embodiments described herein. For example, the processor 1710 may access a first data visualization story arrangement and receive, from a user, a selection of a KPI element of the first data visualization story arrangement. A KPI display widget can then be added to a watchlist layout in the watchlist data store based on the selected KPI element of the first data visualization story arrangement. The processor 1710 may then render a watchlist display, based on the watchlist layout, including the added KPI display widget.

The programs 1712, 1714 may be stored in a compressed, uncompiled and/or encrypted format. The programs 1712, 1714 may furthermore include other program elements, such as an operating system, clipboard application, a database management system, and/or device drivers used by the processor 1710 to interface with peripheral devices. As used herein, information may be “received” by or “transmitted” to, for example: (i) the platform 1700 from another device; or (ii) a software application or module within the platform 1700 from another software application, module, or any other source.

In some embodiments (such as the one shown in FIG. 17), the storage device 1730 further stores a watchlist database 1770, a story database 1780, and enterprise KPIs 1790. Note that the databases mentioned herein are only examples, and additional and/or different information may be stored therein. Moreover, various databases might be split or combined in accordance with any of the embodiments described herein.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of use cases and documentation, any of the embodiments described herein could be applied to other types of use cases and documentation.

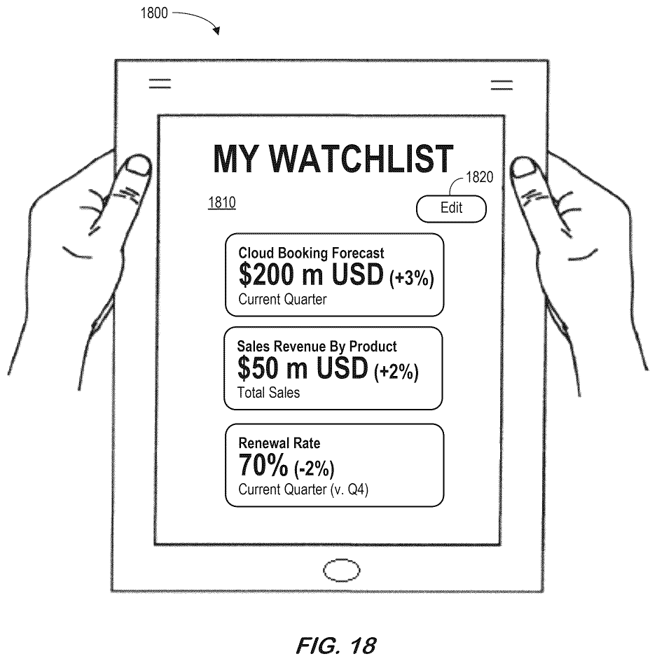

In addition, the displays shown herein are provided only as examples, and any other type of user interface could be implemented. For example, FIG. 18 illustrates a tablet computer 1800 providing a watchlist user display 1810 according to some embodiments. The display 1810 might be used, for example, to inform the user about current enterprise KPIs. A user may interact with the display 1810, such as via an “Edit” icon 1820 (e.g., to change KPI widgets, add visualizations, etc.).

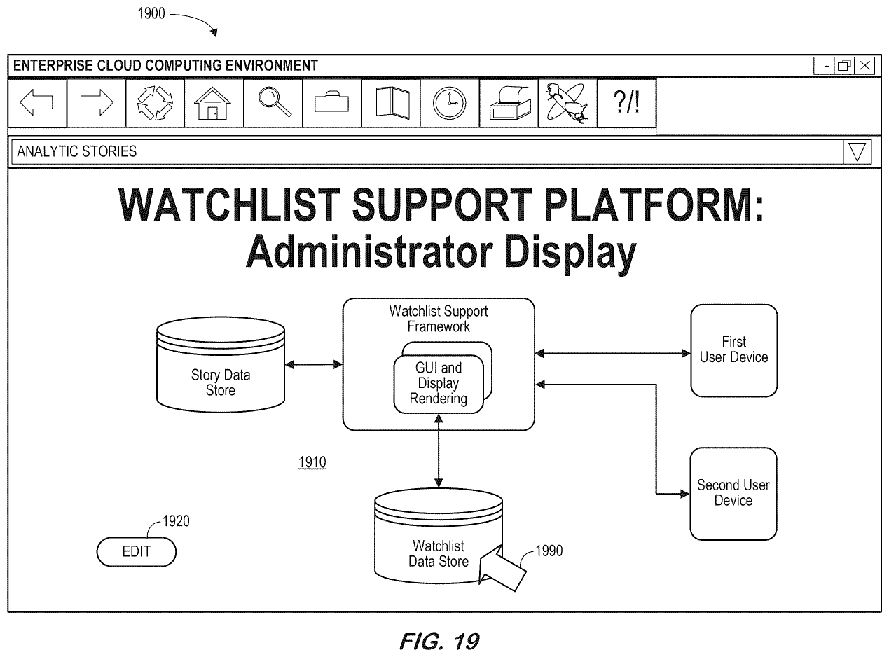

FIG. 19 is a watchlist support display 1900 in accordance with some embodiments. The display 1900 includes a graphical representation 1910 of a watchlist support framework in accordance with any of the embodiments described herein. Selection of an element on the display 1900 (e.g., via a touchscreen or computer pointer 1990) may result in display of a pop-up window containing more detailed information about that element and/or various options (e.g., to define how a data source interacts with the framework, how users communicate with the framework, etc.). Selection of an “Edit” icon 1920 may also let an operator or administrator adjust the operation of the system (e.g., to change a mapping to a data store, create and adjust watchlists, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system, comprising:
a story data store containing electronic records that represent a plurality of data visualization story arrangements associated with Key Performance Indicator (“KPI”) elements of an enterprise, each record including a story identifier;
a watchlist data store containing electronic records that represent a plurality of watchlist layouts associated with the enterprise, each record including a watchlist identifier and at least one KPI display widget; and
a watchlist support platform, coupled to the story and watchlist data stores, including:
a computer processor, and
a computer memory storing instructions that, when executed by the computer processor, cause the watchlist support platform to:
access a first data visualization story arrangement from the story data store,
receive, from a user, a selection of a KPI element of the first data visualization story arrangement,
add a KPI display widget to a watchlist layout in the watchlist data store based on the selected KPI element of the first data visualization story arrangement, and
render a watchlist display, based on the watchlist layout, including the added KPI display widget.

2. The system of claim 1, wherein the KPI elements comprise charts and graphs.

3. The system of claim 1, wherein the watchlist display includes a plurality of KPI display widgets.

4. The system of claim 1, wherein a watchlist layout created by a first user is shared with a second user.

5. The system of claim 1, wherein the watchlist support platform is associated with cloud-based enterprise analytics.

6. The system of claim 5, wherein the system further supports at least one of: (i) KPI insights, (ii) summary insights, (iii) KPI monitoring, (iv) geographic map information, and (v) automatically generated alerts.

7. The system of claim 1, wherein a subsequent change to the data visualization story arrangement does not alter the watchlist layout.

8. The system of claim 1, wherein the rendered watchlist display is based on context information including at least one of: (i) a filter, (ii) a link analysis, (iii) a threshold, (iv) a calculation, (v) a sort, and (vi) a rank.

9. The system of claim 1, wherein a data visualization story arrangement is loaded via Java Script Object Notation (“JSON”).

10. The system of claim 1, wherein a KPI display widget is represented as a Hyper-Text Markup Language (“HTML”) element.

11. A computer-implemented method, comprising:
accessing, by a computer processor of a watchlist support platform, a first data visualization story arrangement from a story data store containing electronic records that represent a plurality of data visualization story arrangements associated with Key Performance Indicator (“KPI”) elements of an enterprise, each record including a story identifier;
receiving, from a user, a selection of a KPI element of the first data visualization story arrangement;
adding, based on the selected KPI element of the first data visualization story arrangement, a KPI display widget to a watchlist layout in a watchlist data store containing electronic records that represent a plurality of watchlist layouts associated with the enterprise, each record including a watchlist identifier and at least one KPI display widget; and
rendering a watchlist display, based on the watchlist layout, including the added KPI display widget.

12. The method of claim 11, wherein the KPI elements comprise charts and graphs.

13. The method of claim 11, wherein the watchlist display includes a plurality of KPI display widgets.

14. The method of claim 11, wherein a watchlist layout created by a first user is shared with a second user.

15. The method of claim 11, wherein at least one of the following are supported: (i) KPI insights, (ii) summary insights, (iii) KPI monitoring, (iv) geographic map information, and (v) automatically generated alerts.

16. One or more non-transitory computer-readable media storing computer-executable instructions that, when executed by a computing system, cause the computing system to perform operations, comprising:
accessing, by a computer processor of a watchlist support platform, a first data visualization story arrangement from a story data store containing electronic records that represent a plurality of data visualization story arrangements associated with Key Performance Indicator (“KPI”) elements of an enterprise, each record including a story identifier;
receiving, from a user, a selection of a KPI element of the first data visualization story arrangement;
adding, based on the selected KPI element of the first data visualization story arrangement, a KPI display widget to a watchlist layout in a watchlist data store containing electronic records that represent a plurality of watchlist layouts associated with the enterprise, each record including a watchlist identifier and at least one KPI display widget; and
rendering a watchlist display, based on the watchlist layout, including the added KPI display widget.

17. The media of claim 16, wherein a subsequent change to the data visualization story arrangement does not alter the watchlist layout.

18. The media of claim 16, wherein the rendered watchlist display is based on context information including at least one of: (i) a filter, (ii) a link analysis, (iii) a threshold, (iv) a calculation, (v) a sort, and (vi) a rank.

19. The media of claim 16, wherein a data visualization story arrangement is loaded via Java Script Object Notation (“JSON”).

20. The media of claim 16, wherein a KPI display widget is represented as a Hyper-Text Markup Language (“HTML”) element.
